(19) United States
(12) Patent Application Publication
(10) Pub. No.: US 2020/0151761 A1
(43) Pub. Date: May 14, 2020

(54) SYSTEMS AND METHODS FOR TARGETED CONTENT DELIVERY BASED ON DEVICE SENSOR DATA

(71) Applicant: Capital One Services, LLC, McLean, VA (US)

(72) Inventors: Jeffrey Wieker, McLean, VA (US); Ya Liu, Arlington, VA (US); Lawrence Hutchison Douglas, JR., McLean, VA (US)

(73) Assignee: Capital One Services, LLC

(21) Appl. No.: 16/184,216

(22) Filed: Nov. 8, 2018

(51) Int. Cl. G06Q 30/02

(52) U.S. Cl. CPC G06Q 30/0255; G06Q 30/0267; G06Q 30/0271; G06Q 30/0224; G06Q 30/0261

(57) ABSTRACT

A system may perform the steps of facilitating targeted content delivery to users. The system may receive demographic data associated with the user. The system may receive, sensor data from a user device associated with a user. The system may receive user data sharing preferences comprising rules that specify types of user information and sensor data accessible by a merchant. The system may determine an allowed dataset comprising a subset of the user information and sensor data that the merchant may access. The system may then receive merchant advertisement rules that designate a type of user to send advertisements to based on available user data. The system may then determine an advertisement to provide to the user and a method of presenting the advertisement to the user. The system may then cause the advertisement to be presented to the user by the determined method.

### FIELD

The presently disclosed subject matter relates generally to systems and methods for content delivery and, more particularly, to systems and methods for facilitating targeted content delivery to users based on device sensor data.

### BACKGROUND

As individuals continue to utilize technology to a greater degree, the amount of data generated by an individual continues to rise. The sheer amount of data presents many opportunities to study and understand patterns. However, individuals are faced with security concerns, as often an individual is not aware of all of the data being that they create, much less what data is being collected and how it is being used.

Accordingly, there is a need for improved systems to for controlling and monetizing mobile sensor data by providing users with the ability to control and manage the data they create. Embodiments of the present disclosure are directed to this and other considerations

### SUMMARY

Consistent with a disclosed embodiment, a system and method for facilitating targeted content deliver to users based on device sensor data is disclosed. The system may comprise one or more processors and a memory in communication with the processor(s) and storing instructions that, when executed by the processor(s), are configured to cause the system to perform operations consistent with disclosed embodiments.

Consistent with the disclosed embodiments, the system may include one or more memory devices storing instructions, and one or more processors configured to execute the instructions to perform steps of a method to facilitate targeted content delivery to users who have control over what data is shared with advertising entities.

According to some embodiments, there is provided a system that may receive user information comprising demographic data associated with the user. The system may then receive, from an application executed on a user device, sensor data from the user device, the user device being associated with a user. Further, the system may receive user data sharing preferences, wherein the user data sharing preferences comprise rules that specify types of user information and sensor data accessible by a merchant. The system may determine, based on the user data sharing preferences, an allowed dataset, wherein the allowed dataset comprises a subset of the user information and the sensor data that the merchant is authorized to access. The system may then receive, from a merchant server associated with the merchant, merchant advertisement rules that designate a type of user to receive advertisements based on available user data. The system may then determine an advertisement to provide to the user by applying the merchant advertising rules to the allowed dataset. Further, the system may determine, based on the sensor data, a method of presenting the advertisement to the user. The system may then cause the advertisement to be presented to the user by the determined method.

According to some embodiments, causing the advertisement to be presented to the user by the determined method may comprises transmitting, to the merchant server, the determined method of presenting the advertisement to the user; receiving, from the merchant server, a user advertisement, wherein the user advertisement comprises the advertisement to send to the user formatted according to the method of presenting the advertisement to the user; and transmitting, to the user device, the user advertisement.

In some embodiments causing the advertisement to be presented to the user by the determined method may comprises transmitting, to the merchant server, the method of presenting the advertisement to the user; and establishing a communication session between the user device and the merchant server.

In some example embodiments, the method of presenting the advertisement to the user may comprise data indicating a device that the advertisement is to be transmitted to and a time that the advertisement is to be transmitted.

According to some example embodiments, the sensor data may comprise location data indicating the location of the user device.

In some embodiments, the method of presenting the advertisement to the user may comprise data representing that the advertisement is to be transmitted to an advertising device proximate the user device within a predetermined amount of time.

According to some embodiments, causing the advertisement to be presented to the user by the determined method may comprise determining, based on the location data, an advertising device that is within a predetermined distance from the user device; and transmitting the advertisement to the advertising device for display.

In some embodiments of the present disclosure, the merchant advertising rules may further designate a method of presenting an advertisement to a user.

According to some example embodiments, merchant advertising rules may comprise data indicating that an advertisement is to be transmitted to a user device within a predetermined amount of time from when it is determined, based on the location data, that the user device enters or exits a specified location.

In some embodiments, the sensor data may further comprise gyroscope and light sensor data.

In such embodiments, determining a method of presenting the advertisement to the user may comprise responsive to determining, based at least in part on the gyroscope and light sensor data, that the probability that the user device is in the user's pocket is below a predetermined threshold, determine that method of presenting the advertisement is to transmit to the advertisement to the user device within a predetermined time period; and responsive to determining, based at least in part on the gyroscope and light sensor data, that the probability that the user device is in the user's pocket is at or above the predetermined threshold, determine that method of presenting the advertisement to the user is to transmit the advertisement to the user device once it is determined that the probability that the user device is in the user's pocket is below the predetermined threshold.

In other example embodiments, determining a method of presenting the advertisement to the user may comprise responsive to determining, based at least in part on the gyroscope and light sensor data, that the probability that the user device is in the user's pocket is at or above a predetermined threshold, determine that method of presenting the advertisement to the user is to transmit the advertisement to an advertising device proximate the user device within a predetermined time period.

According to some example embodiments of the present disclosure, the sensor data may further comprise audio data.

In such example embodiments, determining a method of presenting the advertisement to the user may comprise responsive to determining, based at least in part on the audio data, that a noise level proximate the user's device is below a predetermined threshold, determine that the method of presenting the advertisement to the user is to transmit the advertisement to the user device within a predetermined amount of time, wherein the advertisement is an audio advertisement.

In some example embodiments, the sensor data may further comprise image data.

According to such example embodiments, determining a method of presenting the advertisement to the user may comprise responsive to determining, based at least in part on the image data, that probability that the user is viewing a display of the user device is above a predetermined threshold, determine that method of presenting the advertisement to the user is to transmit the advertisement to the user device within a predetermined amount of time.

Consistent with the disclosed embodiments, the system may include one or more memory devices storing instructions, and one or more processors configured to execute the instructions to perform steps of a method to facilitate targeted content delivery to users who have control over what data is shared with advertising entities.

According to some embodiments, there is provided a system that may receive user information comprising demographic data associated with the user. The system may then receive, from an application executed on a user device, sensor data from the user device, the user device being associated with a user. Further, the system may receive user data sharing preferences, wherein the user data sharing preferences comprise rules that specify types of user information and sensor data accessible by a merchant. The system may determine, based on the user data sharing preferences, an allowed dataset, wherein the allowed dataset comprises a subset of the user information and the sensor data that the merchant is authorized to access. The system may then receive, from a merchant server associated with the merchant, merchant advertisement rules that designate a type of user to receive advertisements based on available user data. The system may then determine an advertisement to provide to the user by applying the merchant advertising rules to the allowed dataset. The system may transmit, to the merchant server, data representing an indication of the type of advertisement to provide to the user. The system may then receive, from the merchant server, user advertising content wherein the user advertising content comprises data representing the content of the type of advertisement to be provided to the user. Further, the system may determine, based on the sensor data, a method of presenting the advertisement to the user. The system may generate an advertisement, wherein the advertisement comprises the user advertising content formatted according to the method of presenting the advertisement to the user. The system may then cause the advertisement to be presented to the user by the determined method.

In some example embodiments, causing the advertisement to be presented to the user by the determined method may comprises transmitting, to the merchant server, the determined method of presenting the advertisement to the user; receiving, from the merchant server, a user advertisement, wherein the user advertisement comprises the advertisement to send to the user formatted according to the method of presenting the advertisement to the user; and transmitting, to the user device, the user advertisement.

Consistent with the disclosed embodiments, the system may include one or more memory devices storing instructions, and one or more processors configured to execute the instructions to perform steps of a method to facilitate targeted content delivery to users who have control over what data is shared with advertising entities.

According to some embodiments, there is provided a system that may receive user information comprising demographic data associated with the user. The system may then receive, from an application executed on a user device, sensor data from the user device, the user device being associated with a user. Further, the system may receive user data sharing preferences, wherein the user data sharing preferences comprise rules that specify types of user information and sensor data accessible by a merchant. The system may determine, based on the user data sharing preferences, an allowed dataset, wherein the allowed dataset comprises a subset of the user information and the sensor data that the merchant is authorized to access. The system may then receive, from a merchant server associated with the merchant, merchant advertisement rules that designate a type of user to receive advertisements based on available user data. The system may then determine an advertisement to provide to the user by applying the merchant advertising rules to the allowed dataset. The system may transmit, to the merchant server, data representing an indication of the type of advertisement to provide to the user. The system may then receive, from the merchant server, user advertising content wherein the user advertising content comprises data representing the content of the type of advertisement to be provided to the user. Further, the system may determine, based on the sensor data, a method of presenting the advertisement to the user. The system may then cause the advertisement to be presented to the user by the determined method. Responsive to receiving an indication that the user of the user device wishes to redeem the advertisement, the system may establish a communication session between the user device and a proximate merchant device.

According to some example embodiments, the advertisement may be a two-way push notification and the proximate merchant device may be a vending device connected to the merchant server and within a predetermined distance from the user device.

Further features of the disclosed design, and the advantages offered thereby, are explained in greater detail hereinafter with reference to specific embodiments illustrated in the accompanying drawings, wherein like elements are indicated be like reference designators.

### BRIEF DESCRIPTION OF THE DRAWINGS

The accompanying drawings, which are incorporated and constitute a part of this specification, illustrate various embodiments and aspects of the disclosed embodiments and, together with the description, serve to explain the principles of the disclosed embodiments. In the drawings:

FIG. 1 illustrates an example system that may be used to facilitate targeted content delivery to users who have control over what data is shared with advertising entities consistent with disclosed embodiments;

FIG. 2 is a component diagram of an example use data management system for use in the system of FIG. 1; and

FIGS. 3-5 are flowcharts of example methods incorporating certain aspects of the present disclosure.

### DETAILED DESCRIPTION

Some implementations of the disclosed technology will be described more fully with reference to the accompanying drawings. This disclosed technology may, however, be embodied in many different forms and should not be construed as limited to the implementations set forth herein. The components described hereinafter as making up various elements of the disclosed technology are intended to be illustrative and not restrictive. Many suitable components that would perform the same or similar functions as components described herein are intended to be embraced within the scope of the disclosed electronic devices and methods. Such other components not described herein may include, but are not limited to, for example, components developed after development of the disclosed technology.

It is also to be understood that the mention of one or more method steps does not preclude the presence of additional method steps or intervening method steps between those steps expressly identified. Similarly, it is also to be understood that the mention of one or more components in a device or system does not preclude the presence of additional components or intervening components between those components expressly identified.

Generally, the disclosed embodiments are directed to systems and methods for content delivery and, more particularly, to systems and methods for facilitating targeted content delivery to users based on device sensor data. In an embodiment, a user may choose what data (e.g., demographic information, contact information, and sensor data generated by a device associated with the user) to share with (or targeted by) merchants. Advertising content can then be generated based on the data that has been shared. Based on information gleaned from sensor data associated with a user device (e.g., that the user device is in a user's pocket, that a user is oriented towards the user device, etc.), the advertisement can be generated in a way that it reaches the user (e.g., sent for display on the user device if the user is facing the device, sent as an audio message if the user device is in the user's pocket and the background noise is below a threshold). The advertisements may be sent to a device associated with the user or to a merchant device that is in the user's vicinity.

In one aspect, a user may wish to have more control over their mobile user data and over the advertisements that they receive. To gain such control, the user may provide to a data management system (e.g., data management system 110 through a mobile application running on user device 120) user information (e.g., identifying information) and user data sharing preferences. For example, the user may specify what type of data (e.g., location data, usage data, etc.) is allowed to go to a single merchant (e.g., Target) or a type of merchant (e.g., grocery stores). The system (e.g., system 100) may then capture and maintain data (e.g., user location data) from the sensors associated with a user device (e.g., user device 120). The system may also receive a list of merchant advertisement rules from a merchant system (e.g., merchant system 140). The merchant adverting rules may indicate what advertising content (e.g., new convertible car ad) is supposed to go to what users (e.g., users under 40 years old, who frequent high end retailers and who commute for work). Based on the comparing the user's data sharing preferences, the system can determine what data can be shared with the merchant and what advertisements are applicable to the user. The system can then determine how best to present the advertisement to the user. For example, based on the sensor data from the user's device, the system can determine whether the user is looking at the screen of their device 120, and, therefore, determine that a pop-up advertisement is an appropriate means for getting the ad to the user. The system 110 can then cause the advertisement to be presented to the user in the determined way (e.g., trigger a pop-up advertisement to the user device 120 if user is oriented towards screen, or an audio message if background noise is quite and user is not oriented towards screen, etc.). As non-limiting examples, the advertisement may take the form of a text message (e.g., an SMS message), a customized robo-call, and a visual, auditory, and/or haptic push-notification (e.g., to the user device 120).

In some implementations, after the system determines what data can be shared with the merchant system and what advertisements are applicable to the user, the system may transmit the information regarding the applicable advertisements to the merchant system and receive back relevant advertising content. For example, the system may transmit information to the merchant system indicating that advertisements about convertibles are relevant to the user and the merchant system may send advertising information (e.g., pricing, visuals, slogans, coupons, etc.) back to the system. The system can then determine how best to present the advertisement to the user. For example, based on the sensor data from the user's device, the system can determine that the user's device (e.g., phone) is most likely in their pocket and can determine that the best way to get the advertisement to the user is to send it to an advertising device in the environment (e.g., television at gas pump, advertising displays at department store's, etc.). The system will then generate the advisement according to the determined method of presenting it and will cause it to be displayed to the user (e.g., via user device 120, via a device incorporated into merchant system 140, or via third-party systems 150A or 150B). For example, the system may generate a personalized video, image, audio, and/or virtual or augmented reality interactive media (e.g., video where the user name is used in order to get the user's attention) and may transmit the video to an advertising device (e.g., an advertising device associated with merchant system 140) close to or proximate the user.

Although certain aspects of the present disclosure are discussed with reference to advertisements and advertising systems, these are merely examples. In light of the present disclosure, one of ordinary skill will recognize that various content may be delivered to users in accordance with aspects of the present invention.

Reference will now be made in detail to example embodiments of the disclosed technology, examples of which are illustrated in the accompanying drawings and disclosed herein. Wherever convenient, the same references numbers will be used throughout the drawings to refer to the same or like parts.

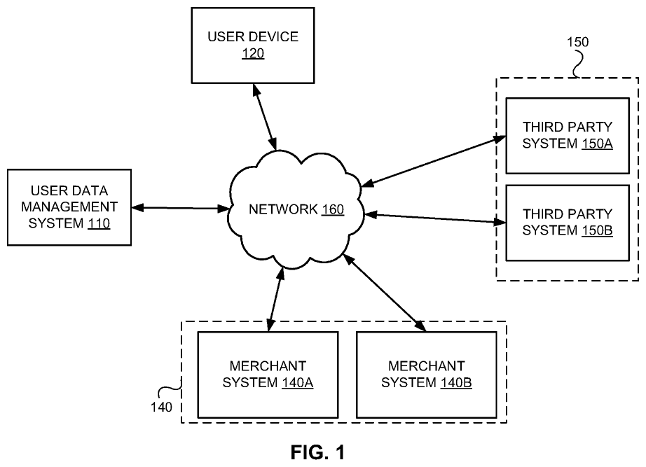

FIG. 1 illustrates an example system 100 consistent with certain disclosed embodiments. In one aspect, as shown, system 100 may include a user data management system 110, a user device 120, a merchant system 140, a third-party system 150, and a network 160. In some embodiments, the user data management system 110, may receive user data and sharing preferences from the user device 120 via the network 160. The user data management system 110 may also receive merchant advertising rules from the merchant system 140 via the network 160. Based on applying the merchant advertising rules to the user data, the user data management system 110 may determine an advertisement to be presented to the user device 120 and a method of presenting the advertisement and may cause the advertisement to be presented by the determined method. In other embodiments, the user data management system 110 may receive advertising content from merchant system 140 via network 160 and may user the advertising content to generate and advertisement to be presented to the user.

The user data management system 110 may be configured to receive customer information and merchant information from a plurality of sources including user device(s) 120, one or more of the merchant system 140, and the third-party system(s) 150. In one aspect, the user data management system 110 may determine an advertisement to be presented to a user of the user device 120 and a method of presenting the advertisement and may cause the advertisement to be presented by the determined method. In some embodiments, user data management system 110 may receive an advertisement from a merchant system 140 and may cause the advertisement to be output (e.g., displayed or played) on the user device 120. According to some embodiments, responsive to receiving an indication from a customer that the customer wishes to redeem an advertisement, user data management system 110 may establish a connection between user device 120 and merchant system 140 in order to facilitate a transaction.

The user device 120 may be a system (e.g., a computer system) associated with a user (e.g., an entity seeking to buy an item from another party). The user device 120 may be configured to transmit and receive information associated with accessing a website, such as a website operated by the user data management system 110, merchant system 140, or third-party system 150. The user device 120 may include one or more components that perform processes consistent with the disclosed embodiments. For example, the user device 120 may include one or more computers (e.g., servers, database systems, etc.) that are configured to execute software instructions programmed to perform aspects of the disclosed embodiments. As non-limiting examples, user device 120 may be a smart phone, tablet, or laptop.

The merchant system 140 may include one or more physical or logical separate merchant systems 140A, 140B, etc. (known collectively as the merchant system 140). The merchant system 140 may be configured to receive, process and transmit information associated with items for sale (e.g., automotive vehicles, clothing, groceries, oil changes, etc.). The merchant system 140 may be associated with a single retail location, or a single retail company having multiple retail locations. The merchant system 140 may include components that enable it to perform processes consistent with the disclosed embodiments. For example, the merchant system 140 may provide websites and/or mobile applications that offer products or services for sale and communicate with the user data management system 110 or other components to provide an advertisement for a product or service listed in the products or services listings.

The third-party system 150 may include multiple separate third-party systems 150A, 150B, etc. (known collectively as the third-party system 150). The third-party system 150 may be configured to receive, process, display, and transmit information associated with items for sale (e.g., automotive vehicles, clothing, groceries, oil changes, etc.). The third-party system 150 may be associated with a third-party to the sale of goods or services (e.g. manufacturers or other parties that do not sell the goods or services but may offer coupons for the goods or services). The third-party system 150 may be associated with the offering of coupons or discounts directly related to goods or services or may offer discounts or coupons for related goods or services. The third-party system 150 may include components that enable it to perform processes consistent with the disclosed embodiments. For example, the third-party system 150 may provide websites and/or mobile applications that offer discounts or coupons for goods and services and communicate with the user data management system 110 or other components to provide an advertisement for a product or service.

Facilitating communication between components of the system 100, the network 160 may be of any suitable type, including individual connections via the Internet such as cellular or WiFi networks. In some embodiments, the network 160 may connect terminals, services, and mobile devices using direct connections such as radio-frequency identification (RFID), near-field communication (NFC), Bluetooth™, low-energy Bluetooth™ (BLE), WiFi™, Ethernet, ZigBee™, ambient backscatter communications (ABC) protocols, USB, WAN, or LAN. Because the information transmitted may be personal or confidential, security concerns may dictate one or more of these types of connections be encrypted or otherwise secured. In some embodiments, however, the information being transmitted may be less personal, and therefore the network connections may be selected for convenience over security.

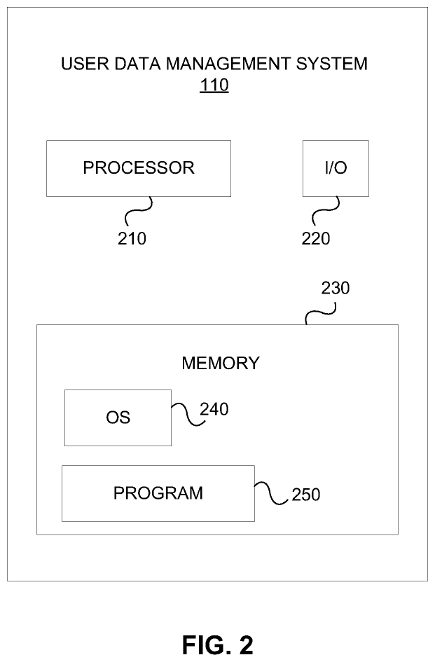

Components of the user data management 110 are shown in more detail in FIG. 2. The user device 120, the merchant system 140, and the third-party system 150 all may have a similar structure and components that are similar to those described with respect to the user data management system 110. As shown in FIG. 2, the user data management system 110 may include a processor 210, an input/output (“I/O”) device 220, a memory 230 containing an operating system (“OS”) 240 and a program 250. For example, the user data management system 110 may be a single server or may be configured as a distributed computer system including multiple servers or computers that interoperate to perform one or more of the processes and functionalities associated with the disclosed embodiments. In some embodiments, the user data management system 110 may further include a display (or a display interface), a peripheral interface, a transceiver, a mobile network interface in communication with the processor 210, a bus configured to facilitate communication between the various components of the user data management system 110, and a power source configured to power one or more components of the user data management system 110. A display may include any conventional display mechanism such as a flat panel display, projector, or any other display mechanism known to those having ordinary skill in the art. In some embodiments, a display, in conjunction with suitable stored instructions, may be used to implement a graphical user interface. In other embodiments, a display may include a display interface configured to receive or communicate with one or more external displays. The user data management system 110 may further include a sound interface, a camera interface, a telephony subsystem, an antenna interface, and a GPS receiver.

A peripheral interface may include the hardware, firmware and/or software that enables communication with various peripheral devices, such as media drives (e.g., magnetic disk, solid state, or optical disk drives), other processing devices, or any other input source used in connection with the instant techniques. In some embodiments, a peripheral interface may include a serial port, a parallel port, a general purpose input and output (GPIO) port, a game port, a universal serial bus (USB), a micro-USB port, a high definition multimedia (HDMI) port, a video port, an audio port, a Bluetooth port, a near-field communication (NFC) port, another like communication interface, or any combination thereof.

In some embodiments, a transceiver may be configured to communicate with compatible devices and ID tags when they are within a predetermined range. A transceiver may be, for example, compatible with one or more of: radio-frequency identification (RFID), near-field communication (NFC), Bluetooth®, low-energy Bluetooth® (BLE), WiFi™, ZigBee®, ambient backscatter communications (ABC) protocols or similar technologies.

A mobile network interface may provide access to a cellular network, the Internet, or another wide-area network. In some embodiments, a mobile network interface may include hardware, firmware, and/or software that allows the processor(s) 210 to communicate with other devices via wired or wireless networks, whether local or wide area, private or public, as known in the art. A power source may be configured to provide an appropriate alternating current (AC) or direct current (DC) to power components.

The processor 210 may include one or more of a microprocessor, microcontroller, digital signal processor, co-processor or the like or combinations thereof capable of executing stored instructions and operating upon stored data. Memory 230 may include, in some implementations, one or more suitable types of memory (e.g. such as volatile or non-volatile memory, random access memory (RAM), read only memory (ROM), programmable read-only memory (PROM), erasable programmable read-only memory (EPROM), electrically erasable programmable read-only memory (EEPROM), magnetic disks, optical disks, floppy disks, hard disks, removable cartridges, flash memory, a redundant array of independent disks (RAID), and the like), for storing files including an operating system, application programs (including, for example, a web browser application, a widget or gadget engine, and or other applications, as necessary), executable instructions and data. In one embodiment, the processing techniques described herein are implemented as a combination of executable instructions and data within the memory 230.

The processor 210 may be one or more known processing devices, such as a microprocessor from the Pentium™ family manufactured by Intel™ or the Ryzen™ family manufactured by AMD™ The processor 210 may constitute a single core or multiple core processor that executes parallel processes simultaneously. For example, the processor 210 may be a single core processor that is configured with virtual processing technologies. In certain embodiments, the processor 210 may use logical processors to simultaneously execute and control multiple processes. The processor 210 may implement virtual machine technologies, or other similar known technologies to provide the ability to execute, control, run, manipulate, store, etc. multiple software processes, applications, programs, etc. In another embodiment, the processor 210 may include a multiple-core processor arrangement (e.g., dual or quad core) that is configured to provide parallel processing functionalities to allow the user data management system 110 to execute multiple processes simultaneously. One of ordinary skill in the art would understand that other types of processor arrangements could be implemented that provide for the capabilities disclosed herein.

The user data management system 110 may include one or more storage devices configured to store information used by processor 210 (or other components) to perform certain functions related to the disclosed embodiments. In one example, the user data management system 110 may include memory 230 that includes instructions to enable processor 210 to execute one or more applications, such as server applications, network communication processes, and any other type of application or software known to be available on computer systems. Alternatively, the instructions, application programs, etc. may be stored in an external storage or available from a memory over a network. The one or more storage devices may be a volatile or non-volatile, magnetic, semiconductor, tape, optical, removable, non-removable, or other type of storage device or tangible computer-readable medium.

In one embodiment, the user data management system 110 includes memory 230 that includes instructions that, when executed by processor 210, perform one or more processes consistent with the functionalities disclosed herein. Methods, systems, and articles of manufacture consistent with disclosed embodiments are not limited to separate programs or computers configured to perform dedicated tasks. For example, the user data management system 110 may include memory 230 that may include one or more programs 250 to perform one or more functions of the disclosed embodiments. Moreover, processor 210 may execute one or more programs 250 located remotely from the enhanced analytical engine system 100. For example, the system 100 may access one or more remote programs 250, that, when executed, perform functions related to disclosed embodiments.

Memory 230 may include one or more memory devices that store data and instructions used to perform one or more features of the disclosed embodiments. Memory 230 may also include any combination of one or more databases controlled by memory controller devices (e.g., server(s), etc.) or software, such as document management systems, Microsoft SQL databases, SharePoint databases, Oracle™ databases, Sybase™ databases, or other relational databases. Memory 230 may include software components that, when executed by processor 210, perform one or more processes consistent with the disclosed embodiments.

The user data management system 110 may also be communicatively connected to one or more memory devices (e.g., databases (not shown)) locally or through a network (e.g., network 160). The remote memory devices may be configured to store information and may be accessed and/or managed by the user data management system 110. By way of example, the remote memory devices may be document management systems, Microsoft SQL database, SharePoint databases, Oracle™ databases, Sybase™ databases, or other relational databases. Systems and methods consistent with disclosed embodiments, however, are not limited to separate databases or even to the use of a database.

The user data management system 110 may also include one or more I/O devices 220 that may comprise one or more interfaces for receiving signals or input from devices and providing signals or output to one or more devices that allow data to be received and/or transmitted by the user data management system 110. For example, the user data management system 110 may include interface components, which may provide interfaces to one or more input devices, such as one or more keyboards, mouse devices, touch screens, track pads, trackballs, scroll wheels, digital cameras, microphones, sensors, and the like, that enable the user data management system 110 to receive data from one or more users. In other example embodiments, the I/O devices 220 may serve as the sound interface and/or the camera interface to present information to a user and capture information from a device's environment including instructions from the device's user. As additional examples, input components may include an accelerometer (e.g., for movement detection), a magnetometer, a digital camera, a microphone (e.g., for sound detection), an infrared sensor, an optical sensor, and a GPS receiver.

In example embodiments of the disclosed technology, the user data management system 110 may include any number of hardware and/or software applications that are executed to facilitate any of the operations. In example implementations, one or more I/O interfaces facilitate communication between the user data management system 110 and one or more input/output devices. For example, a universal serial bus port, a serial port, a disk drive, a CD-ROM drive, and/or one or more user interface devices, such as a display, keyboard, keypad, mouse, control panel, touch screen display, microphone, etc., may facilitate user interaction with the computing device. The one or more I/O interfaces may be utilized to receive or collect data and/or user instructions from a wide variety of input devices. Received data may be processed by one or more computer processors as desired in various implementations of the disclosed technology and/or stored in one or more memory devices.

While the user data management system 110 has been described as one form for implementing the techniques described herein, those having ordinary skill in the art will appreciate that other, functionally equivalent techniques may be employed. For example, as known in the art, some or all of the functionality implemented via executable instructions may also be implemented using firmware and/or hardware devices such as application specific integrated circuits (ASICs), programmable logic arrays, state machines, etc. Furthermore, other implementations of the user data management system 110 may include a greater or lesser number of components than those illustrated.

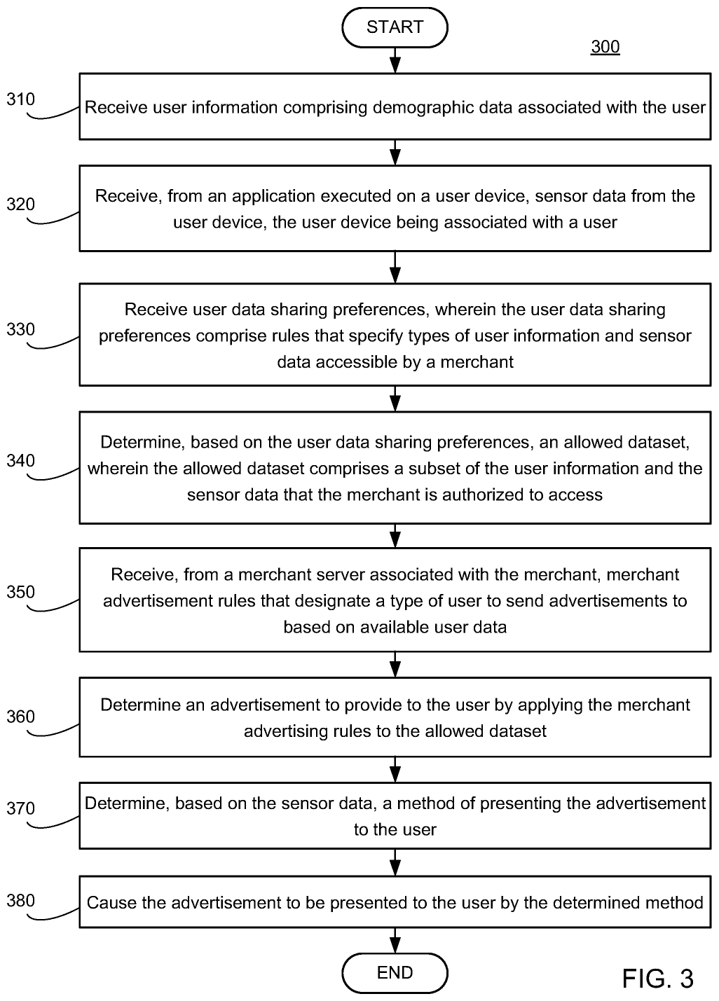

FIG. 3 shows a flowchart of an example method according to an example embodiment. In block 310, the system (e.g., user data management system 110) may receive user information comprising demographic data associated with a user. The user information may include contact information and any other relevant information that would be useful for determining an advertisement that is relevant to the user. For example, in some embodiments, demographic data may include a user's name, date of birth, email address, mailing address, type of vehicle etc. In some embodiments, demographic data may include more general data such as a user's gender, age range, state of residence, etc.

In block 320, the system (e.g., user data management system 110) may receive, from an application executed on a user device sensor data from the user device 120, the user device 120 being associated with a user. In some embodiments, user device sensor data may include location data indicating the location (i.e., GPS data, longitude, latitude, triangulated position from cell tower or Wi-Fi access point, city, state, country, time zone, etc.) of the user device 120. According to some embodiments, user device sensor data may comprise accelerometer data (e.g., if user device 120 includes an accelerometer). In some example embodiments, user device sensor data may comprise gyroscope data (e.g., if user device 120 includes a gyroscope). In some example embodiments, user device sensor data may include one or more of audio data (e.g., captured by a microphone or other audio sensor), image data (e.g., captured through a camera or image sensor), light sensor data (e.g., captured through a light sensor), and/or proximity sensor data (e.g., captured through a proximity sensor). User device 120 may transmit the user device sensor data to the system 110 through network 106.

In block 330, the system (e.g., user data management system 110) may receive user data sharing preferences including rules that specify types of user information and sensor data accessible by a merchant. In some embodiments user data sharing preferences may comprise data indicating the types of (or specific) merchants authorized to access specific types of user data. For example, user data sharing preferences may indicate that grocery stores are able to access a user's location data but are not able to access a user's contact information (e.g., phone number, address, etc.). In another example, user data sharing preference may indicate that banks are able to access a user's personal information but are unable to access a user's location data. According to some embodiments, user data sharing preferences may indicate the types of user data accessible by a single merchant. For example, user data sharing preferences may indicate that American Express is not able to access any user data.

In block 340, the system (e.g., user data management system 110) may determine, based on the user data sharing preferences, an allowed dataset, wherein the allowed dataset comprises a subset of the user information and the sensor data that the merchant is authorized to access. In some embodiments, system 110 will aggregate the user data that the merchant is authorized to access into an allowed dataset. System 110 may then transmit the allowed dataset to the merchant system 104 via network 106.

In block 350, the system (e.g., user data management system 110) may receive, from a merchant server associated with the merchant, merchant advertisement rules that designate a type of user to send, based on available user data, certain advertisements. In some embodiments, system 110 may receive data representing merchant advertising rules from merchant system 104 through network 106. In some embodiments, the merchant advertisement rules may comprise data indicating that users over a certain age and in a certain location should receive certain specified advertising content. In some example embodiments, the merchant advertising rules may further designate a method of presenting an advertisement to a user. For example, the merchant advertising rules may comprise data indicating that an advertisement is to be transmitted to a user device within a predetermined amount of time from when it is determined, based on the location data, that the user device enters or exits a specified location. In another example, the merchant advertising rules may comprise data indicating that an advertisement is to be transmitted to a proximate advertising device when it is determined, based on the allowed data set, that the probability that a user device is in the user's pocket is at or above a predetermined threshold. According to some example embodiments, the merchant advertising rules may comprise data indicating that an advertisement is to be transmitted as an audio advertisement if it is determined that ambient or background noise is below a predetermined threshold.

In block 360, the system (e.g., user data management system 110) may determine an advertisement to provide to the user by applying the merchant advertising rules to the allowed dataset. In some embodiments, system 110 may apply the merchant advertising rules to the allowed dataset in order to determine an advertisement to provide to the user. According to some embodiments, merchant advertising rules may indicate certain advertising content that is to be provided to a certain type of user, which may be determined based on available user data. System 110 may then determine based on the available user data in the allowed data set, what advertisement to send to the customer device (e.g., user device 120). In some embodiments, the advertisement may be a two-way push notification.

In block 370, the system (e.g., user data management system 110) may determine, based on the sensor data, a method of presenting the advertisement to the user. In some embodiments, the method of presenting the advertisement to the user may comprise data indicating one or more of a device that the advertisement is to be transmitted to, a time that the advertisement is to be transmitted, that the advertisement is to be transmitted to an advertising device proximate the user device within a predetermined amount of time, and/or that the advertisement is to be transmitted to user device associated with the user. In some embodiments, the advertisement may be a popup message that will be displayed on the user device upon receipt. According to some embodiments, the advertisement may be an audio message that is played by the user device upon receipt. In some example embodiments, the advertisement may include an alert indication such as an audio alert, a vibrating alert, or other suitable alert to draw the user's attention to the advertisement.

According to some embodiments the sensor data may include gyroscope and light sensor data. Based at least in part on the gyroscope and light sensor data, the system may determine that the probability that the user device is in the user's pocket is below a predetermined threshold. Responsive to this determination, the system may determine that the advertisement is to be transmitted to the user device within a predetermined time period (e.g., so that the advertisement is sent while the phone is not in the user's pocket). In another example, the system may determine, based at least in part on the gyroscope and light sensor data, that the probability that the user device is in the user's pocket is at or above the predetermined threshold. Responsive to this determination, the system may determine that the advertisement is to be transmitted to the user device after it is determined that the probability that the user device is in the user's pocket is below the predetermined threshold (e.g., delay transmission until the device is removed from the user's pocket). In other example embodiments, system may transmit the advertisement to the user device with an indication that the advertisement is not to be presented to the user until after the user device determines that the user device is no longer in the user's pocket. In some embodiments, responsive to determining, based at least in part on the gyroscope and light sensor data, that the probability that the user device is in the user's pocket is at or above a predetermined threshold, the system may determine that advertisement is to be transmitted to an external advertising device proximate the user device within a predetermined time period. For example, the advertisement may be pushed to a monitor in a store or kiosk where the user is located.

In some embodiments, the sensor data includes audio data, and the system determines, based at least in part on the audio data, that a noise level proximate the user's device is below a predetermined threshold. The system may determine that the advertisement should include audio (e.g., music, dialog, or a sound notification) and should be transmitted to the user device within a predetermined amount of time (e.g., while the noise level is low).

According to some embodiments. the sensor data includes image data (e.g., captured from a front-facing camera of the user device), and the system determines, based at least in part on the image data, that probability that the user is viewing a display of the user device is above a predetermined threshold. The system may determine that the advertisement is to be transmitted to the user device within a predetermined amount of time (e.g., while the user is viewing the user device).

In block 380, the system (e.g., user data management system 110) may cause the advertisement to be presented to the user by the determined method. In some embodiments, the system 110 may transmit, to the merchant system 104, the determined method of presenting the advertisement to the user. The system 110 may then receive, from the merchant system 104, a user advertisement, wherein the user advertisement comprises the advertisement to send to the user formatted according to the method of presenting the advertisement to the user. Responsive to that receipt, the system 110 may transmit, to the user device 120, the user advertisement. In some embodiments, the system 110 may transmit, to the merchant system 104, the determined method of presenting the advertisement to the user. The system 110 may then establish a communication session between the user device 120 and merchant system 104. In some embodiments where the method of presenting the advertisement to the user comprises data representing that the advertisement is to be transmitted to an advertising device proximate the user device within a predetermined amount of time, the system may determine, based on the location data, an advertising device that is within a predetermined distance from the user device. In such an example, the system may then transmit the advertisement to the advertising device for display.

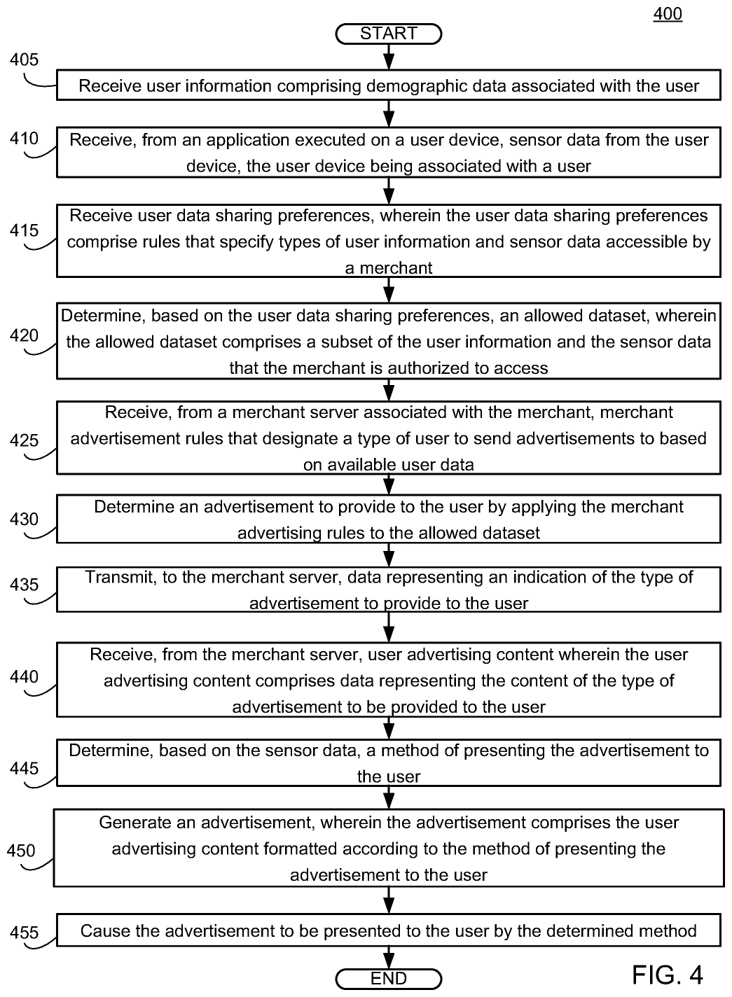

FIG. 4 shows a flowchart of an example method according to an example embodiment. In block 405, the system (e.g., user data management system 110) may receive user information comprising demographic data associated with the user. In block 410, the system (e.g., user data management system 110) may receive, from an application executed on a user device, sensor data from the user device 120, the user device being associated with a user. In block 415, the system (e.g., user data management system 110) may receive user data sharing preferences, wherein the user data sharing preferences comprise rules that specify types of user information and sensor data accessible by a merchant. In block 420, the system (e.g., user data management system 110) may determine, based on the user data sharing preferences, an allowed dataset, wherein the allowed dataset comprises a subset of the user information and the sensor data that the merchant is authorized to access. In block 425, the system (e.g., user data management system 110) may receive, from a merchant server associated with the merchant, merchant advertisement rules that designate a type of user to send advertisements to based on available user data. In block 430, the system (e.g., user data management system 110) may determine an advertisement to provide to the user by applying the merchant advertising rules to the allowed dataset. As will be understood by one of ordinary skill, receiving 405 user information, receiving 410 sensor data, receiving 415 data sharing preferences, determining 420 an allowed dataset, receiving 425 merchant advertisement rules, and determining 430 an advertisement may be substantially similar to the corresponding elements discussed above with reference to FIG. 3 (e.g., blocks 310-360). Accordingly, a detailed description thereof is not repeated for compactness.

In block 435, the system (e.g., user data management system 110) may transmit, to the merchant system, data representing an indication of the type of advertisement to provide to the user. For example, system 110 may transmit data representing an indication of the type of advertisement to provide to the user to merchant system 104 through network 106.

In block 440, the system (e.g., user data management system 110) may receive, from the merchant server, user advertising content wherein the user advertising content comprises data representing the content of the type of advertisement to be provided to the user. In some embodiments, system 110 may receive data representing the content of the type of advertisement to be provided to the user from merchant system 104 through network 106. For example, in some embodiments, user advertising content may include information relating to a product that the merchant wants to advertise to the user. In some, user advertising content may include information regarding a service that the merchant wants to advertise to the user.

In block 445, the system (e.g., user data management system 110) may determine, based on the sensor data, a method of presenting the advertisement to the user. One of ordinary skill will recognize that determining 445 a method of presenting the advertisement to the user may be similar to that described above with reference to block 370. Accordingly, a detailed description thereof is not repeated for compactness.

In block 450, the system (e.g., user data management system 110) may generate an advertisement based on the user advertising content formatted according to the method of presenting the advertisement to the user (i.e., the system formats the advertisement according to the determined presentation method). In some embodiments, user data management system 110 may generate an audio advertisement related to a sale at a department store when the user advertising content relates to the sale and the method of presenting the advertisement to the user is determined to be an audio advertisement. According to some embodiments, user data management system 110 may generate a text-based advertisement related to a vehicle of interest when the user advertising content relates to the vehicle of interest and the method of presenting the advertisement to the user is determined to be an audio advertisement.

In block 455, the system (e.g., user data management system 110) may cause the advertisement to be presented to the user by the determined method. One of ordinary skill will recognize that causing 455 the advertisement to be presented to the user may be similar to that described above with reference to block 380. Accordingly, a detailed description thereof is not repeated for compactness.

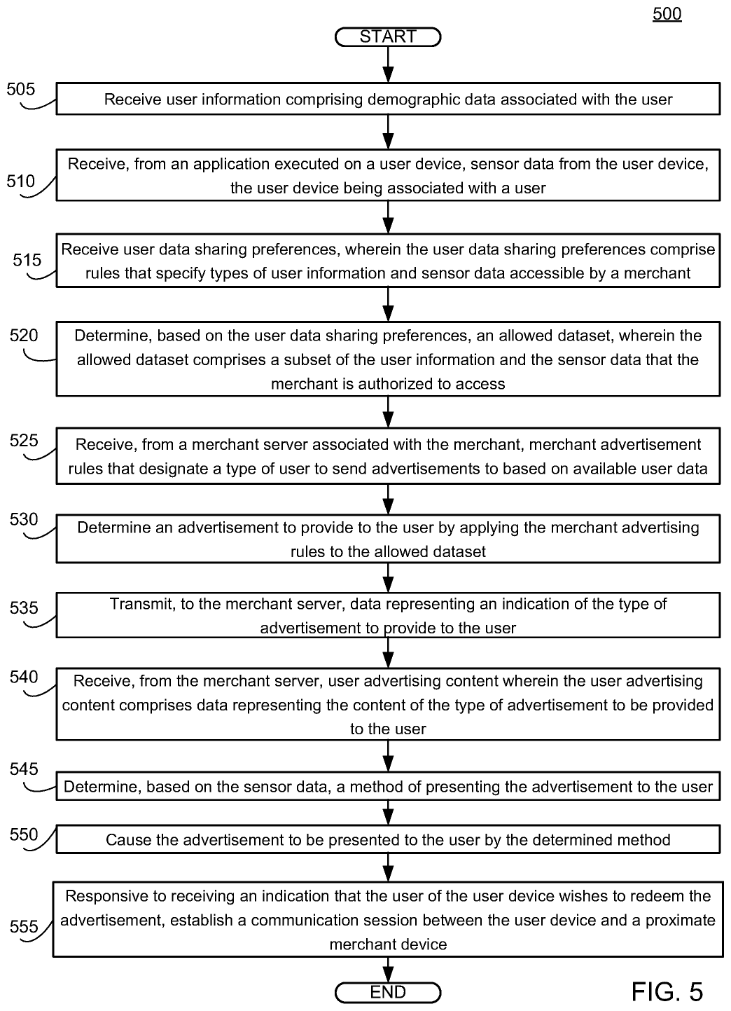

FIG. 5 shows a flowchart of an example method according to an example embodiment. In block 505, the system (e.g., user data management system 110) may receive user information comprising demographic data associated with the user. In block 510, the system (e.g., user data management system 110) may receive, from an application executed on a user device, sensor data from the user device 120, the user device being associated with a user. In block 515, the system (e.g., user data management system 110) may receive user data sharing preferences, wherein the user data sharing preferences comprise rules that specify types of user information and sensor data accessible by a merchant. In block 520, the system (e.g., user data management system 110) may determine, based on the user data sharing preferences, an allowed dataset, wherein the allowed dataset comprises a subset of the user information and the sensor data that the merchant is authorized to access. In block 525, the system (e.g., user data management system 110) may receive, from a merchant server associated with the merchant, merchant advertisement rules that designate a type of user to send advertisements to based on available user data. In block 530, the system (e.g., user data management system 110) may determine an advertisement to provide to the user by applying the merchant advertising rules to the allowed dataset. As will be understood by one of ordinary skill, receiving 505 user information, receiving 510 sensor data, receiving 515 data sharing preferences, determining 520 an allowed dataset, receiving 525 merchant advertisement rules, and determining 530 an advertisement may be substantially similar to the corresponding elements discussed above with reference to FIG. 3 (e.g., blocks 310-360) and to FIG. 4 (e.g., blocks 405-430). Accordingly, a detailed description thereof is not repeated for compactness.

In block 535, the system (e.g., user data management system 110) may transmit, to the merchant system, data representing an indication of the type of advertisement to provide to the user. In block 540, the system (e.g., user data management system 110) may receive, from the merchant server, user advertising content wherein the user advertising content comprises data representing the content of the type of advertisement to be provided to the user. As will be understood by one of ordinary skill, transmitting 535 data representing an indication of the type of advertisement and receiving 540 user advertising content may be substantially similar to the corresponding elements discussed above with reference to FIG. 4 (e.g., blocks 435-440). Accordingly, a detailed description thereof is not repeated for compactness.

In block 545, the system (e.g., user data management system 110) may determine, based on the sensor data, a method of presenting the advertisement to the user. In block 550, the system (e.g., user data management system 110) may cause the advertisement to be presented to the user by the determined method. As will be understood by one of ordinary skill, determining 545 a method of presenting the advertisement and causing 550 the advertisement to be presented may be substantially similar to the corresponding elements discussed above with reference to FIG. 3 (e.g., blocks 370-380) and to FIG. 4 (e.g., blocks 445 & 455). Accordingly, a detailed description thereof is not repeated for compactness.

In block 555, responsive to receiving an indication that the user of the user device 120 wishes to redeem the advertisement, the system (e.g., user data management system 110) may establish a communication session between the user device and a proximate merchant device. According to some embodiments, the advertisement may be a two-way push notification and the proximate merchant device is a vending device associated with the merchant server and within a predetermined distance from the user device. In some embodiments, a user may select an option indicating that they wish to purchase a product incorporated into the advertisement. For example, if the advertisement is for a bottle of water for $1.00, the user may indicate a willingness to purchase the bottle of water through the vending machine. User data management system 110 may then initiate a communication session between user device 120 associated with the user and vending device incorporated within merchant system 104. For example, system may trigger payment from user device 120 to vending device from user account information stored on the customer device.

### Example Use Cases

The following example use cases describe examples of typical flow patterns. These are intended solely for explanatory purposes and not in limitation. A user may wish to have more control over their mobile user data. To gain such control, the user may provide to a data management system (e.g., a mobile application running on user device) user information (e.g., identifying information). The system may then capture and maintain data from the sensors associated with the user device. For example, system may track user location data. The user may then provide the system with user data sharing preferences. For example, the user may specify what type of data (e.g., location data, usage data, etc.) is allowed to go to a single merchant (e.g., Target) or a type of merchant (e.g., grocery stores). The system may also receive a list of merchant advertisement rules from a merchant. For example, the merchant adverting rules may provide what advertising content (e.g., new convertible car ad) is supposed to go to what users (e.g., users under 40 years old, who frequent high end retailers and who commute for work). Based on the comparing the user's data sharing preferences, the system can determine what data can be shared with the merchant and can determine what advertisements are applicable to the user. The system can then determine how best to present the advertisement to the user. For example, based on the sensor data from the user's device, the system can determine if the user oriented towards the screen of their device, and if they are can determine that a pop-up advertisement is an appropriate means for getting the ad to the user. The system can then cause the advertisement to be presented to the user by the determined method (e.g., pop-up advertisement if user is oriented towards screen, or audio message if background noise is quite and user is not oriented towards screen, etc.).

As another example, a user may wish to have more control over their mobile user data. To gain such control, the user may provide to a data management system (e.g., a mobile application running on user device) user information (e.g., identifying information). The system may then capture and maintain data from the sensors associated with the user device. For example, system may track user location data. The user may then provide the system with user data sharing preferences. For example, the user may specify what type of data (e.g., location data, usage data, etc.) is allowed to go to a single merchant (e.g., Target) or a type of merchant (e.g., grocery stores). The system may also receive a list of merchant advertisement rules from a merchant. For example, the merchant adverting rules may provide what advertising content (e.g., new convertible car ad) is supposed to go to what users (e.g., users under 40 years old, who frequent high end retailers and who commute for work). Based on the comparing the user's data sharing preferences, the system can determine what data can be shared with the merchant and can determine what advertisements are applicable to the user. The system can then transmit the information regarding the applicable advertisements to the merchant and may receive back relevant advertising content. For example, the system may transmit information to the merchant indicating that advertisements relevant to convertibles are relevant to the user and the merchant may send advertising information (e.g., pricing, visuals, slogans, coupons, etc.) back to the system. The system can then determine how best to present the advertisement to the user. For example, based on the sensor data from the user's device, the system can determine that the user's phone is most likely in their pocket and can determine that the best way to get the advertisement to the user is to send it to an advertising device (e.g., television at gas pump, advertising displays at department store's, etc.). The system will then generate the advisement according to the determined method of presenting it and will cause it to be displayed to the user. For example, the system may generate a personalized video (e.g., video where the user name is used in order to get the user's attention) and may transmit the video to a merchant advertising device close to the user.

As used in this application, the terms “component,” “module,” “system” and the like are intended to include a computer-related entity, such as but not limited to hardware, firmware, a combination of hardware and software, software, or software in execution. For example, a component may be, but is not limited to being, a process running on a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

Certain implementations of the disclosed technology are described above with reference to block and flow diagrams of systems and methods and/or computer program products according to example implementations of the disclosed technology. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, may be repeated, or may not necessarily need to be performed at all, according to some implementations of the disclosed technology.

These computer-executable program instructions may be loaded onto a general-purpose computer, a special-purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks. As an example, implementations of the disclosed technology may provide for a computer program product, including a computer-usable medium having a computer-readable program code or program instructions embodied therein, said computer-readable program code adapted to be executed to implement one or more functions specified in the flow diagram block or blocks. Likewise, the computer program instructions may be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions, and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

Throughout the specification and the claims, the following terms take at least the meanings explicitly associated herein, unless the context clearly dictates otherwise. The term “connected” means that one function, feature, structure, or characteristic is directly joined to or in communication with another function, feature, structure, or characteristic. The term “coupled” means that one function, feature, structure, or characteristic is directly or indirectly joined to or in communication with another function, feature, structure, or characteristic. The term “or” is intended to mean an inclusive “or.” Further, the terms “a,” “an,” and “the” are intended to mean one or more unless specified otherwise or clear from the context to be directed to a singular form.

In this description, numerous specific details have been set forth. It is to be understood, however, that implementations of the disclosed technology may be practiced without these specific details. In other instances, well-known methods, structures and techniques have not been shown in detail in order not to obscure an understanding of this description. References to “one embodiment,” “an embodiment,” “some embodiments,” “example embodiment,” “various embodiments,” “one implementation,” “an implementation,” “example implementation,” “various implementations,” “some implementations,” etc., indicate that the implementation(s) of the disclosed technology so described may include a particular feature, structure, or characteristic, but not every implementation necessarily includes the particular feature, structure, or characteristic. Further, repeated use of the phrase “in one implementation” does not necessarily refer to the same implementation, although it may.

As used herein, unless otherwise specified the use of the ordinal adjectives “first,” “second,” “third,” etc., to describe a common object, merely indicate that different instances of like objects are being referred to, and are not intended to imply that the objects so described must be in a given sequence, either temporally, spatially, in ranking, or in any other manner.

While certain implementations of the disclosed technology have been described in connection with what is presently considered to be the most practical and various implementations, it is to be understood that the disclosed technology is not to be limited to the disclosed implementations, but on the contrary, is intended to cover various modifications and equivalent arrangements included within the scope of the appended claims. Although specific terms are employed herein, they are used in a generic and descriptive sense only and not for purposes of limitation.

This written description uses examples to disclose certain implementations of the disclosed technology, including the best mode, and also to enable any person skilled in the art to practice certain implementations of the disclosed technology, including making and using any devices or systems and performing any incorporated methods. The patentable scope of certain implementations of the disclosed technology is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A system for targeted content delivery, comprising:
one or more processors; and
a memory in communication with the one or more processors and storing instructions that, when executed by the one or more processors, are configured to cause the system to:
receive user information comprising demographic data associated with a user;
collect, from an application executed on a user device associated with the user, environmental sensor data, the user device being remote from the system;
receive user data sharing preferences, wherein the user data sharing preferences comprise rules that specify types of user information and environmental sensor data accessible by a merchant;
determine, based on the user data sharing preferences, an allowed dataset, wherein the allowed dataset comprises a subset of the user information and the environmental sensor data that the merchant is authorized to access;
receive, from a merchant server associated with the merchant, merchant advertisement rules that designate a type of user to send advertisements to based on available user data;
determine an advertisement to provide to the user by applying the merchant advertising rules to the allowed dataset;
determine, based on the environmental sensor data, a method of presenting the advertisement to the user; and
cause the advertisement to be presented to the user by the determined method.

2. The system of claim 1, wherein causing the advertisement to be presented to the user by the determined method comprises:
transmitting, to the merchant server, the determined method of presenting the advertisement to the user;
receiving, from the merchant server, a user advertisement, wherein the user advertisement comprises the advertisement to send to the user formatted according to the method of presenting the advertisement to the user; and
transmitting, to the user device, the user advertisement.

3. The system of claim 1, wherein causing the advertisement to be presented to the user by the determined method comprises:
transmitting, to the merchant server, the method of presenting the advertisement to the user; and
establishing a communication session between the user device and the merchant server.

4. The system of claim 1, wherein the method of presenting the advertisement to the user comprises data indicating a device that the advertisement is to be transmitted to and a time that the advertisement is to be transmitted.

5. The system of claim 4, wherein the environmental sensor data comprises location data indicating the location of the user device.

6. The system of claim 5, wherein the method of presenting the advertisement to the user comprises data representing that the advertisement is to be transmitted to an advertising device proximate the user device within a predetermined amount of time.

7. The system of claim 6, wherein causing the advertisement to be presented to the user by the determined method comprises:
determining, based on the location data, an advertising device that is within a predetermined distance from the user device; and
transmitting the advertisement to the advertising device for display.

8. The system of claim 5, wherein the merchant advertising rules further designate a method of presenting an advertisement to a user.

9. The system of claim 8, wherein the merchant advertising rules comprise data indicating that an advertisement is to be transmitted to a user device within a predetermined amount of time from when it is determined, based on the location data, that the user device enters or exits a specified location.

10. The system of claim 5, wherein the environmental sensor data further comprises gyroscope and light sensor data.

11. The system of claim 10 wherein determining a method of presenting the advertisement to the user comprises:
responsive to determining, based at least in part on the gyroscope and light sensor data, that a probability that the user device is in the user's pocket is below a predetermined threshold, determine that method of presenting the advertisement is to transmit to the advertisement to the user device within a predetermined time period; and
responsive to determining, based at least in part on the gyroscope and light sensor data, that the probability that the user device is in the user's pocket is at or above the predetermined threshold, determine that method of presenting the advertisement to the user is to transmit the advertisement to the user device once it is determined that the probability that the user device is in the user's pocket is below the predetermined threshold.

12. The system of claim 10, wherein determining a method of presenting the advertisement to the user comprises:
responsive to determining, based at least in part on the gyroscope and light sensor data, that a probability that the user device is in the user's pocket is at or above a predetermined threshold, determine that method of presenting the advertisement to the user is to transmit the advertisement to an advertising device proximate the user device within a predetermined time period.

13. The system of claim 5, wherein the environmental sensor data further comprises audio data.

14. The system of claim 13 wherein determining a method of presenting the advertisement to the user comprises:
responsive to determining, based at least in part on the audio data, that a noise level proximate the user's device is below a predetermined threshold, determine that the method of presenting the advertisement to the user is to transmit the advertisement to the user device within a predetermined amount of time, wherein the advertisement is an audio advertisement.

15. The system of claim 5, wherein the environmental data further comprises image data.

16. The system of claim 15, wherein determining a method of presenting the advertisement to the user comprises:
responsive to determining, based at least in part on the image data, that probability that the user is viewing a display of the user device is above a predetermined threshold, determine that method of presenting the advertisement to the user is to transmit the advertisement to the user device within a predetermined amount of time.

17. A system for targeted content delivery, comprising:
one or more processors; and
a memory in communication with the one or more processors and storing instructions that, when executed by the one or more processors, are configured to cause the system to:
receive user information comprising demographic data associated with a user;
access an application executed on a user device associated with the user to collect environmental sensor data, the user device being remote from the system;
receive user data sharing preferences, wherein the user data sharing preferences comprise rules that specify types of user information and environmental sensor data accessible by a merchant;
determine, based on the user data sharing preferences, an allowed dataset, wherein the allowed dataset comprises a subset of the user information and the sensor data that the merchant is authorized to access;
receive, from a merchant server associated with the merchant, merchant advertisement rules that designate a type of user to send advertisements to based on available user data;
determine an advertisement to provide to the user by applying the merchant advertising rules to the allowed dataset;
transmit, to the merchant server, data representing an indication of the type of advertisement to provide to the user;
receive, from the merchant server, user advertising content wherein the user advertising content comprises data representing the content of the type of advertisement to be provided to the user;
determine, based on the environmental sensor data, a method of presenting the advertisement to the user; and
generate an advertisement, wherein the advertisement comprises the user advertising content formatted according to the method of presenting the advertisement to the user; and
cause the advertisement to be presented to the user by the determined method.

18. The system of claim 17, wherein causing the advertisement to be presented to the user by the determined method comprises:
transmitting, to the merchant server, the determined method of presenting the advertisement to the user;
receiving, from the merchant server, a user advertisement, wherein the user advertisement comprises the advertisement to send to the user formatted according to the method of presenting the advertisement to the user; and
transmitting, to the user device, the user advertisement.

19. A system for targeted content delivery, comprising:
one or more processors; and
a memory in communication with the one or more processors and storing instructions that, when executed by the one or more processors, are configured to cause the system to:
receive user information comprising demographic data associated with a user;
collect, from an application executed on a user device associated with the user, environmental sensor data; collect, from an application executed on a user device associated with the user, environmental sensor data, the user device being remote from the system;
receive user data sharing preferences, wherein the user data sharing preferences comprise rules that specify types of user information and environmental sensor data accessible by a merchant;
determine, based on the user data sharing preferences, an allowed dataset, wherein the allowed dataset comprises a subset of the user information and the environmental sensor data that the merchant is authorized to access;
receive, from a merchant server associated with the merchant, merchant advertisement rules that designate a type of user to send advertisements to based on available user data;
determine an advertisement to provide to the user by applying the merchant advertising rules to the allowed dataset;
transmit, to the merchant server, data representing an indication of the type of advertisement to provide to the user;
receive, from the merchant server, user advertising content wherein the user advertising content comprises data representing the content of the type of advertisement to be provided to the user;
determine, based on the environmental sensor data, a method of presenting the advertisement to the user; and
cause the advertisement to be presented to the user by the determined method; and
responsive to receiving an indication that the user of the user device wishes to redeem the advertisement, establish a communication session between the user device and a proximate merchant device.

20. The system of claim 19, wherein the advertisement is a two way push notification and the proximate merchant device is a vending device connected to the merchant server and within a predetermined distance from the user device.
